(19) United States
(12) Patent Application Publication
(10) Pub. No.: US 2021/0324915 A1
(43) Pub. Date: Oct. 21, 2021

(54) SEALED BEARING

(71) Applicant: NACHI-FUJIKOSHI CORP, Tokyo (JP)

(72) Inventor: Daisuke Horikoshi, Toyama (JP)

(21) Appl. No.: 16/852,398

(22) Filed: Apr. 17, 2020

(51) Int. Cl. F16C 33/78; F16C 33/58; F16C 41/00

(52) U.S. Cl. CPC F16C 33/7816; F16C 33/7889; F16C 2208/14; F16C 41/002; F16C 2202/32; F16C 33/58

(57) ABSTRACT

An object of the present invention is to provide a sealed bearing that can reduce electromagnetic noise at all times. A sealed bearing (bearing 100) according to the present invention includes a seal 110 for covering a ball 106 from a side between an inner ring 102 and an outer ring 104. The seal 110 is formed of a conductive resin material, and when an oil film parameter of a track surface of the bearing 100 is 1.0 or more, an impedance of a circuit that passes through the inner ring 102 and the outer ring 104 via the seal 110 is smaller than an impedance of a circuit that passes through the inner ring 102 and the outer ring 104 via the ball 106.

### TECHNICAL FIELD

The present invention relates to a sealed bearing provided with a seal for covering a rolling element from a side between an inner bearing ring and an outer bearing ring.

### BACKGROUND

In recent years, due also to progress in the development of electric cars (EV), hybrid cars (HV), and the like, the number of high voltage components installed in an automobile has been increasing. An increase in the number of high voltage components leads to an increase in electromagnetic interference between the components. When such electromagnetic interference propagates to an electronic device such as in-vehicle radio, the electromagnetic interference may adversely affect the operation of the device as electromagnetic noise. As such, countermeasures for electromagnetic noise in vehicles are currently desired. In particular, the inventors of the present application have considered approaches to mitigate electromagnetic noise by using bearings installed at various locations in a vehicle.

Patent Document 1 below discloses a conductive rolling bearing as a conductive bearing. This conductive rolling bearing is provided with a conductive seal ring 10a mainly in order to prevent electrolytic corrosion of a rolling element. The seal ring 10a is a component for preventing leakage of lubricant oil, intrusion of foreign matter, and the like, and conductivity is improved by enclosing ambient temperature molten salt in a tip end portion of the seal lip 14.

### RELATED DOCUMENTS

### Patent Documents

Patent Document 1: JP 2009-264401A

### Problems to be Solved

In considering the mitigation of electromagnetic noise when using the bearing described above, the inventors of the present application considered configurations where the electromagnetic noise could be released when using the conductive seal without being influenced by operational environment changes. For example, the ease with which electricity flows through the bearing is influenced by the size of the contact area of the rolling element with the bearing rings, in other words, the thickness of an oil film between the rolling body and the bearing rings. The oil film becomes thin in situations in which the rotation speed is low and the load is large, such as when the vehicle is stopped or driving at a low speed, and becomes thick in situations in which the rotation speed is high and the load is small, such as when the vehicle is driving at a high speed. Accordingly, in order to reduce electromagnetic noise via the bearing at all times, it is important to also handle situations in which the oil film is thick.

### SUMMARY

In view of the above problems, an object of the present invention is to provide a sealed bearing that can reduce electromagnetic noise originating from the installation target at all times.

### Means to Solve the Problems

In an approach to solve the above problem, a representative configuration of a sealed bearing consistent with the present invention includes a sealed bearing comprising a seal for covering a rolling element from a side between an inner bearing ring and an outer bearing ring, the seal being formed of a conductive resin material, and when an oil film parameter of a track surface of the sealed bearing is 1.0 or more, an impedance of a circuit that passes through the inner bearing ring and the outer bearing ring via the seal is smaller than an impedance of a circuit that passes through the inner and outer bearing rings via the rolling element.

The oil film parameter is a measure indicating an extent to which friction surfaces are in direct contact with each other, and a value of 1.0 or more indicates a state in which the oil film is sufficiently thick. In the above-described configuration, when the oil film is thick, in other words, even when the bearing rings and the rolling element are not overly in contact with each other, it is possible to realize an electrical circuit that passes through the inner and outer bearing rings by using the seal. With this configuration, it is possible to reduce electromagnetic noise at all times including times when the vehicle is running and when the vehicle is stopped. Also, with this configuration, by configuring the electrical circuit by preferentially using the conductive seal, it is also possible to suppress electrolytic corrosion of the rolling element.

The above-described resin material may include at least one of nitrile rubber, acryl rubber, fluoro rubber, and silicone rubber. With these configurations, it is possible to utilize the characteristics of the materials to realize the seal having characteristics based on the installation target, such as heat resistance and abrasion resistance, for example.

### Technical Effect

According to the present invention, it is possible to provide a sealed bearing that can reduce electromagnetic noise originating from the installation target at all times.

### BRIEF DESCRIPTION OF THE DRAWINGS

FIG. 1 is a diagram showing an overview of a sealed bearing according to an embodiment of the present invention.

FIG. 2 is a graph showing a relationship between an oil film parameter and an impedance of the bearing.

FIG. 3(a) is a diagram showing an overview of a lip portion of a seal.

FIG. 3(b) is a graph showing a relationship between the contact area S of the lip portion 118 and the impedance.

FIG. 3(c) is a graph showing the relationship between the oil film thickness d of the lip portion 118 and the impedance.

FIGS. 4(a), 4(b), and 4(c) are diagrams showing first to third modifications of the bearing according to the present invention.

FIGS. 5(a), 5(b), and 5(c) are diagrams showing fourth to sixth modifications of the bearing according to the present invention.

### DETAILED DESCRIPTION

The following paragraphs describe to some embodiments of the present invention in detail with reference to the accompanying drawings. Dimensions, materials, other specific numerical values, and the like described in the embodiments are merely examples to facilitate understanding and do not limit the present inventions unless otherwise stated. It should be noted that elements that have substantially the same function and configuration are denoted with the same reference signs in the specification and drawings and redundant description of those elements is omitted, and illustration or description of elements that do not directly relate to the present inventions are omitted.

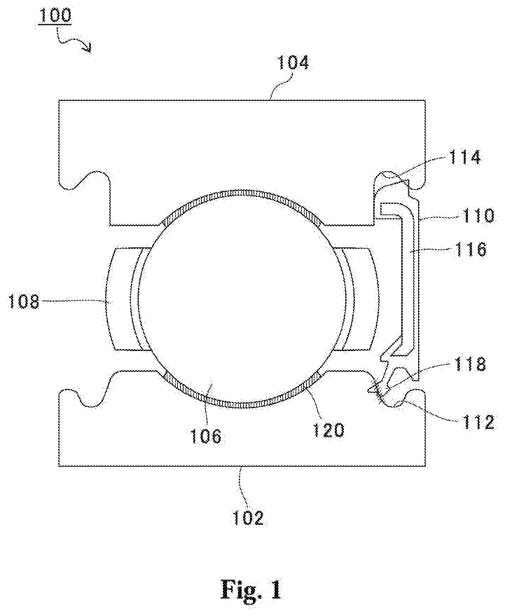

FIG. 1 is a diagram showing an overview of a sealed bearing (hereinafter, a bearing 100) according to an embodiment of the present invention. The bearing 100 is realized as a single-row deep groove ball bearing provided with a single-row ball 106 serving as a rolling element and a holder 108 between an inner ring 102 and an outer ring 104. The bearing 100 is provided with a contact-type seal 110 on one side. The seal 110 covers the ball 106 from a side between the inner and outer bearing rings, and also forms a conductive circuit between the inner ring 102 and the outer ring 104 while preventing leakage of a lubricating oil, intrusion of foreign matter, and so on.

The seal 110 is fitted into a seal groove 112 of the inner ring 102 and a seal groove 114 of the outer ring 104. The seal 110 is formed of a resin material and provided with a core metal 116 in the center in order to supplement the pressure-resistance, strength, and conductivity. A lip portion 118 is provided on the inner ring 102 side of the seal 110, and due to the lip portion 118 contacting the seal groove 112, prevention of intrusion of foreign matter and the like are performed.

The bearing 100 is assumed to be utilized in the inner mechanism of electric cars, for example, and realizes a configuration that can mitigate and/or eliminate electromagnetic noise originating from the installation target. Accordingly, with the bearing 100, it is possible for electricity to flow between the inner ring 102 and the outer ring 104 to a certain extent. Specifically, in some embodiments, an electrical circuit passing through the seal 110 may be formed in preference to an electrical circuit passing through the ball 106.

In order to achieve the above-described object, the seal 110 is formed of a conductive resin material. Specifically, the seal 110 may be formed of acrylic rubber including a conductive filler. With the above configuration, it is possible to ensure not only conductivity but also heat-resistance. Accordingly, the seal 110 can effectively function even in an environment in which the temperature tends to be high such as the inner mechanism of a vehicle and the like.

The impedance of the circuit passing through the seal 110 is set to a value at which electricity can easily pass through compared to the case in which the circuit passes through the ball 106, for example, on a basis of the ball 106 being a steel ball. In general, the ease with which electricity flows between the rolling element and the bearing ring is influenced by the thickness of the oil film between the rolling element and the bearing ring. The oil film of the bearing becomes thin under a high pressure in which the mechanism is stopped or operating at a low speed, and becomes thick under a low pressure and no-load state in which the mechanism is operating at a high speed. In the present embodiment, the impedance is set so that electricity flows through the seal 110 rather than the ball the ball 106 based on the thickness of the oil film 120 so that electromagnetic noise can be eliminated in any situation such as when the mechanism is operating or stopped.

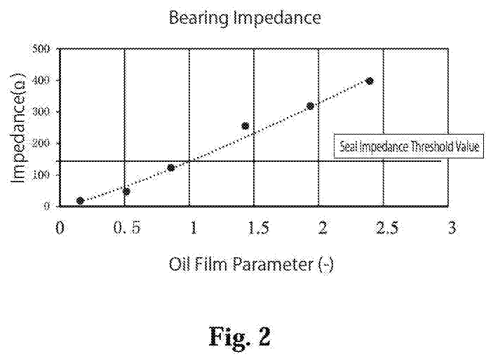

FIG. 2, for example, is a graph showing a relationship between the oil film parameter and the impedance of the bearing. The oil film parameter on the horizontal axis is a measure (in some specified unit (-)) indicating the extent to which friction surfaces are in direct contact with each other. The vertical axis indicates the impedance (Ω) of the bearing. Generally, the oil film parameter indicates the extent to which the oil film is formed on the track surface, and is used as an index with regard to the lifetime of the rolling bearing. The value of the oil film parameter (symbol Λ) is expressed as: Λ=d/(σ₁²+σ₂²)^{1/2}. The term d denotes the minimum thickness of the oil film between the steel ball and the outer ring (or inner ring), σ₁ denotes the surface roughness of the steel ball, and σ₂ denotes the surface roughness of the outer ring (or inner ring).

The plots in FIG. 2 indicate values with regard to a conventional ball bearing, which is not provided with the seal 110 (that is present in described embodiments). In other words, the impedance on the vertical axis corresponds to the impedance of an electrical circuit that passes through the inner ring 102 and the outer ring 104 via the ball 106 in FIG. 1. From this graph, it can be recognized that a larger magnitude of the oil film parameter (Λ) results in a larger impedance of the bearing. In other words, this indicates that the thicker the oil film 120 of the track surface is, the more difficult it becomes for electricity to flow through the conventional bearing.

In the present embodiment, a threshold value of impedance of the electrical circuit that passes through the ball 106 when the oil film parameter (Λ) of the track surface is 1.0 is determined (e.g. approximately 150Ω in FIG. 2) such that electricity can flow even when the oil film 120 of the track surface (see FIG. 1) is thick. The impedance of the seal 110 is set to a lower value than the above impedance threshold value.

With the above-described configuration, it is possible to realize an electrical circuit that passes through the inner ring 102 and the outer ring 104 using the seal 110 even when the mechanism is operating at a high speed and the oil film 120 is thick. Of course, since the seal 110 is a contact-type seal, the electrical circuit is formed between the inner and outer bearing rings even in the situation in which the mechanism is stopped or operating at a low speed. In other words, with the configuration of the present embodiment, it is possible to lower the bearing impedance by passing through the seal 110 both when the mechanism is operating and stopped, and therefore electromagnetic noise can be reduced at all times. Furthermore, in the present embodiment, it is also possible to suppress electrolytic corrosion of the ball 106 by configuring the electrical circuit preferentially using the conductive seal 110 rather than the ball 106.

Particularly, since the thickness of the oil film of the track surface is thicker in a high-speed rotation region, the impedance becomes smaller and electricity flows more easily in the seal portion.

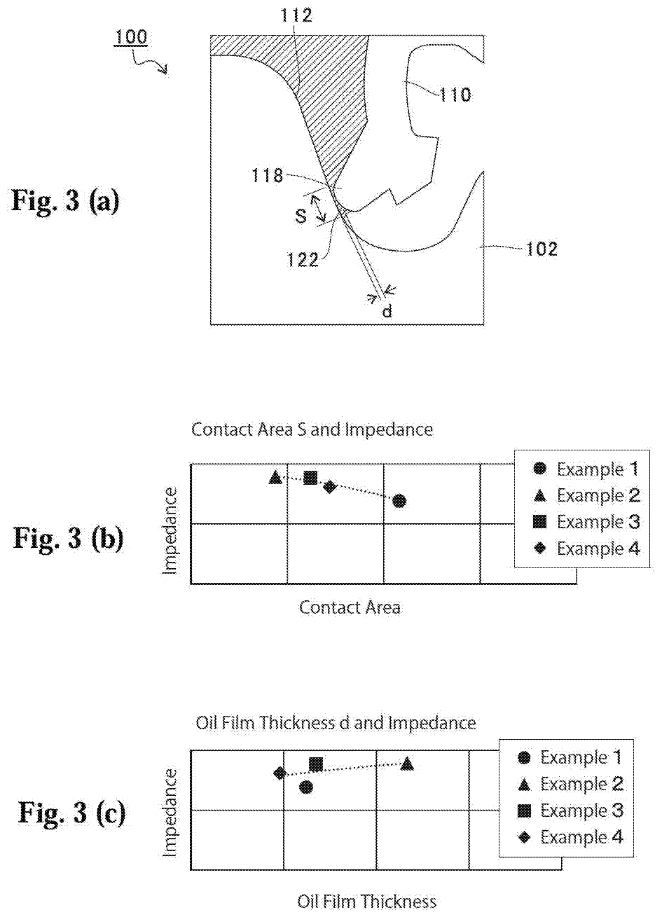

FIG. 3(a) is a diagram showing an overview of a lip portion 118 of the seal 110. Hereinafter, the method for setting the impedance of the seal 110 will be illustrated with reference to FIG. 3(a).

FIG. 3(a) is an enlarged view of the lip portion 118. In the vicinity of the lip portion 118, the oil film 122, which is an insulating body, is present between the lip portion 118 and the seal groove 112 of the inner ring 102, which are both conductors. This state can be considered as a capacitor in which a dielectric body is filled between conductors.

Here, an impedance (Z) of a typical capacitor is expressed by the following expression 1.

Z=−j1/ωC Expression 1

j=imaginary unit; ω=2πf (AC angular frequency); c=capacitance (electrostatic capacity)

Also, generally, the capacitance C of the capacitor in the above Expression 1 is expressed as the following expression 2. In this Expression 2, a capacitor in which a dielectric body is filled between two parallel conductors is assumed.

C=εS/d Expression 2

ε=electric permittivity of dielectric body; S=area of conductors; d=interval (or distance) between conductors

According to the above Expressions 1 and 2, it is evident that the impedance of the electrical circuit that passes through the above-described seal 110 can be adjusted by using the contact area S between the lip portion 118 and the seal groove 112, and the oil film thickness d between the lip portion 118 and the seal groove 112 in FIG. 3(a).

The result of measurement of the relationship of the impedance of the electrical circuit that passes through the seal 110 with the contact area S and the oil film thickness d is shown below. FIG. 3(b) is a graph showing a relationship between the contact area S of the lip portion 118 and the impedance. The horizontal axis indicates the contact area between the lip portion 118 and the seal groove, and the vertical axis indicates the impedance of the electrical circuit that passes through the seal 110. The working examples 1 to 4 show bearings respectively having different contact areas S of the lip portions 118 and the oil film thicknesses d (see FIG. 3(a)). From FIG. 3(b), it can be confirmed that the larger the contact area S of the lip portion 118 is, the smaller the impedance becomes.

FIG. 3(c) is a graph showing the relationship between the oil film thickness d of the lip portion 118 and the impedance. The horizontal axis indicates the oil film thickness between the lip portion 118 and the seal groove 112, and the vertical axis indicates the impedance of the electrical circuit that passes through the seal 110. From FIG. 3(c), it can be confirmed that the larger the oil film thickness d of the lip portion 118 is, the larger the impedance is.

From the above description, it can be confirmed that the impedance of the electrical circuit that passes through the seal 110 can be adjusted by increasing and decreasing the contact area S of the lip portion 118 and the oil film thickness d. By adjusting in this manner, it is possible to realize the sealed bearing 100 that can form an electrical circuit having impedance that is less than or equal to the above-described threshold value (see FIG. 2) using the seal 110, and that can reduce electromagnetic noise at all times.

The bearing 100 is provided with the seal 110 formed of conductive acrylic rubber and to which the above-described impedance has been set, and therefore it is possible to effectively install the bearing 100 in electric cars, hybrid cars, and the like, especially in a differential, a transmission shaft, and the like. With the bearing 100, it is possible to reduce electromagnetic noise at all times both when the vehicle is running and when the vehicle is stopped. Furthermore, acrylic rubber is heat-resistant, and it is possible to enhance the usable temperature of the bearing to as high as 150 C.° or more as one example. Accordingly, with the bearing 100, it is possible for the bearing to function effectively even in a location in which the temperature becomes high such as the differential or the transmission.

As described above, although conductive acrylic rubber is adopted as a material of the seal 110 in the present embodiment, other resin materials can also be adopted. For example, nitrile rubber has an excellent wear resistance, and fluoro rubber has a high heat resistance and a high chemical resistance. Also, silicone rubber has a high heat resistance and a high cold resistance. With these resin materials, by imparting conductivity with a conductive filler, it is possible to utilize the characteristics of the materials to realize the seal 110 having characteristics based on the installation target, and the sealed bearing 100 that can reduce electromagnetic noise at all times.

### Modifications

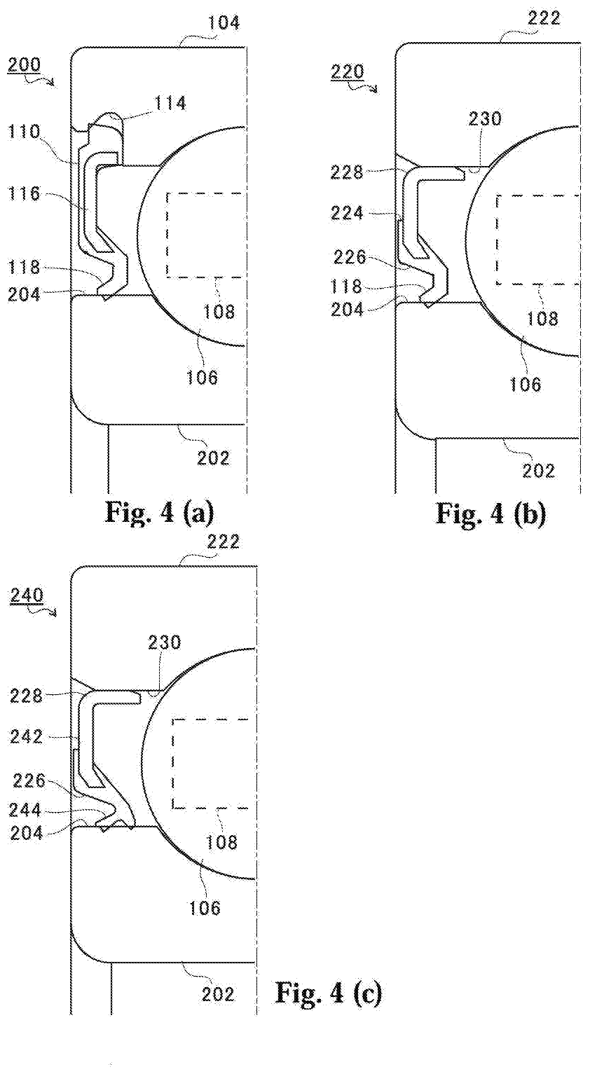

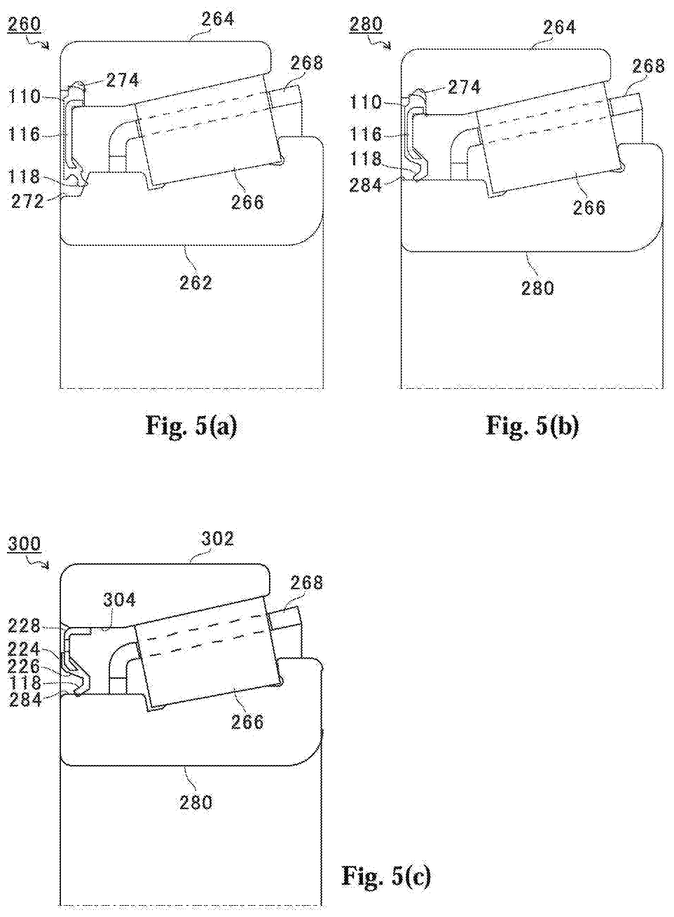

Hereinafter, modifications of the constituent elements described above will be illustrated. In FIGS. 4 and 5, the constituent elements that are the same as those described before are given the same reference numerals and description thereof will be omitted. Also, in the following descriptions, unless otherwise stated, the constituent elements that have the same name as those described before are assumed to have the same functions even if the elements have different reference numerals.

FIGS. 4(a), 4(b), and 4(c) are diagrams showing first to third modifications, respectively, of the bearing according to the present invention. The bearings shown in the first to third modifications are, similar to the bearing 100, examples in which the present invention is implemented as a deep groove ball bearing. FIG. 4(a) is a diagram showing a bearing 200 according to the first modification. In the bearing 200, the seal groove 112 (see FIG. 1) is omitted from an inner ring 202, and the lip portion 118 on the inner side of the seal 110 is in contact with a flat outer circumferential surface 204 of the inner ring 202 (shoulder portion of the inner ring). Similar to the bearing 100 in FIG. 1, with the bearing 200 with this configuration as well, it is possible to adjust the impedance by increasing and decreasing the contact area between the lip portion 118 and the outer circumferential surface 204 of the inner ring 202.

FIG. 4(b) is a diagram showing a bearing 220 according to the second modification. In the bearing 220, the seal groove 114 (see FIG. 1) is also omitted from an outer ring 222. In a seal 224 included in the bearing 220, only the inner ring side is covered by the resin material (resin portion 226), and a core metal 228 is exposed on the outer ring side. The seal 224 also forms an electrical circuit between the inner ring 202 and the outer ring 222.

The core metal 228 bends toward the ball along an inner circumferential surface 230 of the outer ring 222, and is in surface contact with the inner circumferential surface 230 of the outer ring 222. The seal 224 is pressed in between the inner ring 202 and the outer ring 222 (interference-fit), and the lip portion 118 slides along the outer circumferential surface 204 of the inner ring 202. With this bearing 220 as well, it is possible to adjust the impedance by increasing and decreasing the contact area between the lip portion 118 and the outer circumferential surface 204 of the inner ring 202.

FIG. 4(c) is a diagram showing a bearing 240 according to the third modification. A seal 242 included in the bearing 240 is in contact with the outer circumferential surface 204 of the inner ring 202 at two positions at which a lip portion 244 branches into two parts. The contact area (see contact area S shown in FIG. 3(a)) between the seal 242 configured as above and the inner ring 202 is large compared to the seal 224 in FIG. 4(b). Accordingly, with the bearing 240, the impedance of the electrical circuit formed by the seal 242 decreases (see FIG. 3(b)), making it easy for electricity flow through the seal 242. In other words, by the bearing 240 adopting the seal 242, it is possible to improve the reduction effect of electromagnetic noise.

FIGS. 5(a), 5(b), and 5(c) are diagrams showing fourth to sixth modifications, respectively of the bearing according to the present invention. Unlike the bearing 100, in the bearings of the fourth to sixth modifications, the present invention is realized as a single row conical bearing.

FIG. 5(a) is a diagram showing a bearing 260 according to the fourth modification. The bearing 260 is provided, between an inner ring 262 and an outer ring 264, with rollers 266 arranged in a single row along a cone and a holder 268. The bearing 260 is also provided with the contact-type seal 110 on one side. The seal 110 is fitted into a seal groove 272 of the inner ring 262 and a seal groove 274 of the outer ring 264. In this bearing 260 as well, since the seal 110 forms an electrical circuit between the inner ring 262 and the outer ring 264, it is possible to reduce electromagnetic noise originating from the installation target at all times.

FIG. 5(b) is a diagram showing a bearing 280 according to the fifth modification. Similarly to the bearing 200 in FIG. 4(a), the bearing 280 is configured such that the seal groove 272 (see FIG. 5(a)) is omitted from an inner ring 282, and the lip portion 118 on the inner ring side of the seal 110 is in contact with a flat outer circumferential surface 284 of the inner ring 282. In the bearing 280 configured as above as well, similar to the bearing 100 in FIG. 1, it is possible to adjust the impedance by increasing and decreasing the contact area between the lip portion 118 and the outer circumferential surface 284 of the inner ring 282.

FIG. 5(c) is a diagram showing a bearing 300 according to the sixth modification. In the bearing 300, the seal groove 274 (see FIG. 5(b)) is also omitted from an outer ring 302. Also, in the bearing 300 as well, similar to the bearing 240 in FIG. 4(b), the seal 224 is pressed in, and an electrical circuit is formed between the inner ring 280 and the outer ring 302 via the seal 224. In the seal 224, the core metal 228 is in surface contact with an inner circumferential surface 304 of the outer ring 302, and the lip portion 118 slides along the outer circumferential surface 284 of the inner ring 282. In the bearing 300 as well, it is possible to adjust the impedance by increasing and decreasing the contact area between the lip portion 118 and the outer circumferential surface 284 of the inner ring 282.

As described above, the sealed bearing according to the present invention can be favorably realized as various kinds of bearings such as a deep groove ball bearing and a conical roller bearing. In any of the bearings as which the present invention is realized, due to the provision of the conductive seal, it is possible to favorably reduce electromagnetic noise originating from the installation target.

Although a preferable embodiment of the present invention has been described with reference to the drawings, needless to say, the present invention is not limited to this embodiment. A person skilled in the art will appreciate that various variations and modifications can be arrived at within the scope of the appended claims, and those variations and modifications should be understood to be included within the technical scope of the present invention.

### INDUSTRIAL APPLICABILITY

The present invention can be used as a sealed bearing provided with a seal for covering a rolling element from a side between inner and outer bearing rings.

### INDEX TO THE REFERENCE NUMERALS

100 . . . bearing;
102 . . . inner ring;
104 . . . outer ring;
106 . . . ball;
108 . . . holder;
110 . . . seal;
112 . . . seal groove of inner ring;
114 . . . seal groove of outer ring;
116 . . . core metal;
118 . . . lip portion;
120 . . . oil film of ball;
122 . . . oil film of lip portion;
S . . . contact area of lip;
d . . . thickness of oil film of lip;
200 . . . bearing of first modification;
202 . . . inner ring;
204 . . . outer circumferential surface of inner ring;
220 . . . bearing of second modification;
222 . . . outer ring;
224 . . . seal;
226 . . . resin portion;
228 . . . core metal;
230 . . . inner circumferential surface of outer ring;
240 . . . bearing of third modification;
242 . . . seal;
244 . . . lip portion;
260 . . . bearing of fourth modification;
262 . . . inner ring;
264 . . . outer ring;
268 . . . holder;
272 . . . seal groove of inner ring;
274 . . . seal groove of outer ring;
280 . . . bearing of fifth modification;
282 . . . inner ring;
284 . . . outer circumferential surface of inner ring;
300 . . . bearing of sixth modification;
302 . . . outer ring;
304 . . . inner circumferential surface of outer ring

1. A sealed bearing comprising a seal for covering a rolling element from a side between an inner bearing ring and an outer bearing ring, wherein
the seal is formed of a conductive resin material, and
when an oil film parameter of a track surface of the sealed bearing is 1.0 or more, an impedance of a circuit that passes through the inner bearing ring and the outer bearing ring via the seal is smaller than an impedance of a circuit that passes through the inner and outer bearing rings via the rolling element.

2. The sealed bearing according to claim 1, wherein
the resin material includes at least one of: nitrile rubber, acryl rubber, fluoro rubber, or silicone rubber.
